(19) United States
(12) Patent Application Publication
(10) Pub. No.: US 2013/0010814 A1
(43) Pub. Date: Jan. 10, 2013

(54) NODE DEVICE, COMMUNICATION SYSTEM AND TIME SYNCHRONIZATION METHOD

(75) Inventor: Masatake Miyabe, Kawasaki (JP)

(73) Assignee: FUJITSU LIMITED, Kawasaki-shi (JP)

(21) Appl. No.: 13/532,207

(22) Filed: Jun. 25, 2012

(30) Foreign Application Priority Data
Jul. 6, 2011 (JP) 2011-149651

(51) Int. Cl. H04J 3/06

(52) U.S. Cl. 370/503

(57) ABSTRACT

A node device that conducts time synchronization processing, the node device including: a processor configured to measure a reception time of a time synchronization message transmitted addressed to another node device from a master node device, the time synchronization message including information of a transmission time from the master node device, to detect the time synchronization message, and extracts information of the transmission time from the detected time synchronization message, and to correct a time in the processor based on the extracted information of the transmission time and the information of the reception time, and a transmitter configured to forward the time synchronization message to the another node device when the time synchronization message received by a receiver addressed to the another node device.

### CROSS-REFERENCE TO RELATED APPLICATIONS

This application is based upon and claims the benefit of priority of the prior Japanese Patent Application No. 2011-149651, filed on Jul. 6, 2011, the entire contents of which are incorporated herein by reference.

### FIELD

The embodiments discussed herein relate to a node device and a communication system that conducts synchronization processing between a plurality of devices.

### BACKGROUND

A communication system having a plurality of nodes connected in a network preferably ensures precise timing to simplify event synchronization and data correlation. For example, Ethernet (registered trademark) is employed in a communication system as an infrastructure technology, such as local area network (LAN), to support a packet network. Ethernet in a communication system is also employed in data communication in which transmission delays and data loss during transmission of audio and video data greatly affect the quality of the received data.

Demand is increasing for a function to monitor transmission delays, delay fluctuation, and data loss during transmission to improve the transmission quality of data communication in a communication system. One example of a function to monitor transmission quality is a method to measure transmission delay using a function called “one-way ETH-DM” prescribed in ITU-T Recommendation Y.1731. This method involves the synchronization of a time beforehand between nodes connected at either end of a range in which transmission delay is to be measured. After the synchronization, a transmitting node transmits a message called “1DM” to a receiving node. The transmitting node inserts information of the transmission time of the message into the 1DM. The receiving node receives the message 1DM, stores the reception time and extracts the information of transmission time from the message 1DM. The receiving node is able to determine a transmission delay time between the receiving node and the transmitting node from a difference between the stored reception time and the transmission time extracted from the message.

This method of determining the transmission delay time from the difference between the transmission time and the reception time is predicated upon the synchronization of the transmitting and receiving nodes. Time synchronization based on IEEE 1588 is an example of a method to achieve synchronization between nodes. IEEE 1588 prescribes a standard protocol to synchronize clocks connected through a network such as Ethernet that allows multicasting and the like. Multicasting refers to transmitting packets at the same time to a plurality of predetermined nodes. In IEEE 1588, the units that transmit messages for time adjustment alternate back and forth and the results of the time adjustments of the two units are compared. If deviation between the time adjustment results of the two units occurs, the nodes may be synchronized by correcting the deviation to align the time. International Publication Pamphlet No. WO 2008/129593, International Publication Pamphlet No. WO 2008/129594, and Japanese Laid-open Patent Publication No. 2005-253033 discuss techniques relating to time synchronization between nodes.

### SUMMARY

According to an aspect of the invention, a node device that conducts time synchronization processing, the node device including: a processor configured to measure a reception time of a time synchronization message transmitted addressed to another node device from a master node device, the time synchronization message including information of a transmission time from the master node device, to detect the time synchronization message, and extracts information of the transmission time from the detected time synchronization message, and to correct a time in the processor based on the extracted information of the transmission time and the information of the reception time, and a transmitter configured to forward the time synchronization message to the another node device when the time synchronization message received by a receiver addressed to the another node device. The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a communication system;

FIG. 2 is a detailed block diagram of a master node;

FIG. 3 is a detailed block diagram of a relay slave node;

FIG. 4A illustrates a configuration of a time synchronization message, and FIG. 4B illustrates a configuration of a Sync control signal;

FIG. 5 is a sequence diagram illustrating a flow of time synchronization processing;

FIG. 6 is a sequence diagram explaining a synchronization process of the relay slave node;

FIG. 7 is a sequence diagram explaining an operation of the relay slave node after monitoring processing has started;

FIG. 8 is a sequence diagram explaining a synchronization process of the relay slave node after a failure has occurred; and

FIG. 9 illustrates a process flow of the relay slave node.

### DESCRIPTION OF EMBODIMENTS

Time synchronization is desired between multiple nodes making up a communication system when a function to monitor transmission delays of multiple service flows is provided in a communication system. A node that provides a reference clock is called a master node, and a node that is synchronized with the master node is called a slave node. When a plurality of slave nodes are connected to one master node, the master node performs time synchronization individually with each of the slave nodes. Consequently, as the number of slave nodes connected to the master node increases, the amount of time synchronization processing by the master node correspondingly increases.

An object of the embodiment described herein is to reduce a synchronization processing load on the master node and to reduce the amount of communication between the master node and the slave node during time synchronization processing.

An embodiment will be described herein with reference to the accompanying drawings. The embodiment described herein also includes combinations of configurations in various embodiments.

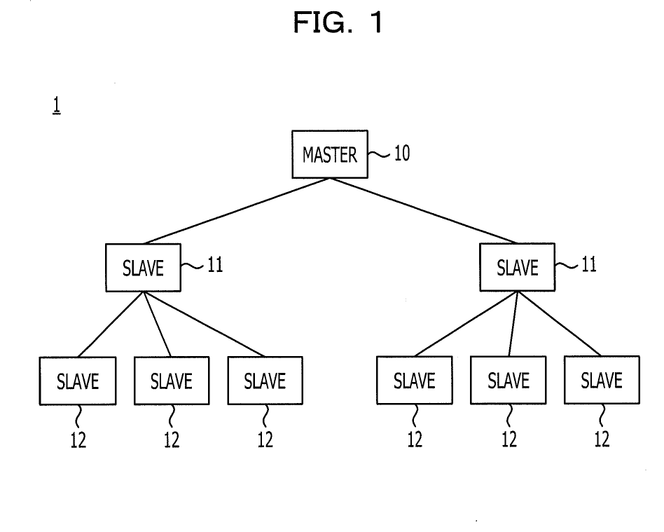

FIG. 1 is a block diagram of a communication system 1 according to the embodiment described herein. The communication system 1 includes a master node 10, and slave nodes 11 and 12. In the present embodiment, the slave nodes connected to the master node 10 include the slave node 12, which is connected to the master node 10 at the farthest end and is called a “terminal slave node,” and the slave node 11, which is connected to the master node 10 in between the terminal slave node and the master node 10 and is called a “relay slave node.”

The master node 10 is a node that operates with the most precise master clock on the network. The relay slave node 11 and the terminal slave node 12 are nodes that are network-connected to the master node 10. The communication system 1 causes slave clocks of the relay slave node 11 and the terminal slave node 12 to be synchronized with the master clock of the master node 10. In the embodiment illustrated in FIG. 1, a plurality of relay slave nodes 11 are connected to one master node 10, and each of the relay slave nodes 11 are connected to a plurality of the terminal slave nodes 12. An explanation of the present embodiment will discuss one relay slave node 11 connected to the master node 10 and one terminal slave node 12 connected to the one relay slave node 11.

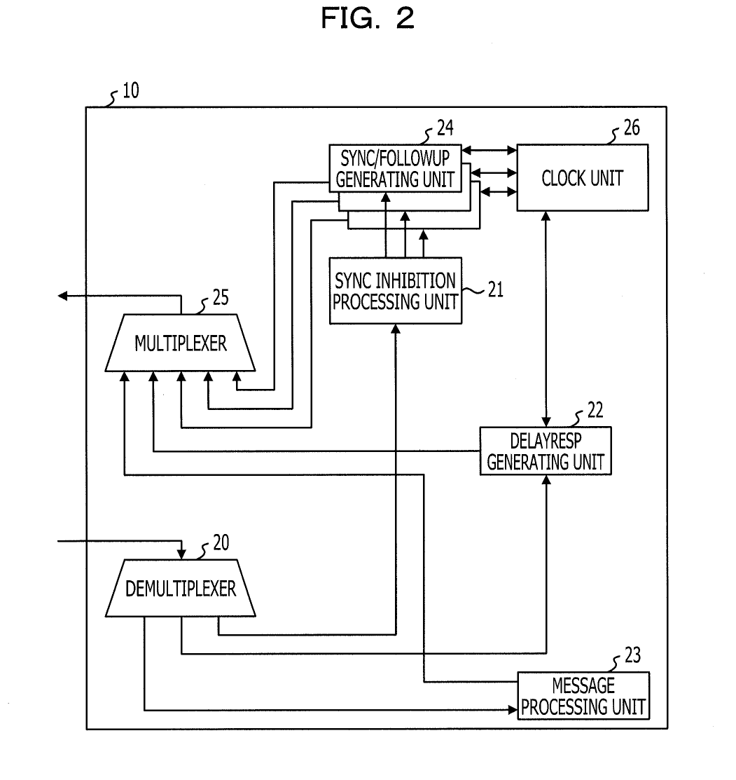

FIG. 2 is a detailed block diagram of a master node 10. The master node 10 includes a demultiplexer 20, a Sync/FollowUp generating unit 24, a Sync inhibition processing unit 21, a DelayResp generating unit 22, a message processing unit 23, a multiplexer 25, and a clock unit 26.

The demultiplexer 20 separates a packet signal received from another slave node into a Sync inhibition request signal, a DelayReq message, and other messages. The demultiplexer 20 transmits the Sync inhibition request signal to the Sync inhibition processing unit 21, transmits the DelayReq message to the DelayResp generating unit 22, and transmits the other messages to the message processing unit 23. The Sync inhibition request signal is a packet signal containing a request from an external unit to stop the output of a Sync/FollowUp message outputted by the master node 10. The DelayReq message is a signal transmitted from slave nodes connected to the master node 10. The other messages are other signals relating to time synchronization processing transmitted from the slave nodes connected to the master node 10.

The Sync inhibition processing unit 21 transmits a Sync inhibition signal to the Sync/FollowUp generating unit 24 when the Sync inhibition request signal is received from the demultiplexer 20. The number of the Sync/FollowUp generating units 24 is the same as the number of slave nodes. Addresses of the slave nodes that are packet signal transmission destinations are previously registered in each of the Sync/FollowUp generating units 24.

The Sync/FollowUp generating unit 24 periodically generates Sync messages and FollowUp messages, and functions as a generating unit to transmit the messages to the multiplexer 25. The Sync/FollowUp generating unit 24 reads time information of the transmission time of the Sync messages from the clock unit 26 and inserts the time information in the generated FollowUp messages. When a Sync inhibition signal is received from the Sync inhibition processing unit 21, the Sync/FollowUp generating unit 24 stops outputting the Sync and FollowUp messages to the specified address.

The DelayResp generating unit 22 generates a DelayResp message and outputs the message to the multiplexer 25 when a DelayReq message is received from the demultiplexer 20. The DelayResp generating unit 22 reads the reception time of the corresponding DelayReq message from clock unit and inserts the time information into the generated DelayResp message.

Upon receiving a message from the demultiplexer 20, the message processing unit 23 outputs a processing message corresponding to the contents of the received message to the multiplexer 25. The message transmitted to the message processing unit 23 is an IEEE 1588 message other than a Sync message, a FollowUp message, the DelayReq message, or the DelayResp message.

The clock unit 26 measures the time of the master node 10. The clock unit 26 transmits requested time information according to read requests from the Sync/FollowUp generating unit 24 and the DelayResp generating unit 22.

The multiplexer 25 functions as a transmission unit that multiplexes the Sync message and the FollowUp message transmitted from the Sync/FollowUp generating unit 24, the DelayResp message transmitted from the DelayResp generating unit 22, and a message packet transmitted from the message processing unit 23, and externally transmits the multiplexed messages as a serial signal.

The above-mentioned master node 10 is capable of processing messages transmitted from the plurality of terminal slave nodes.

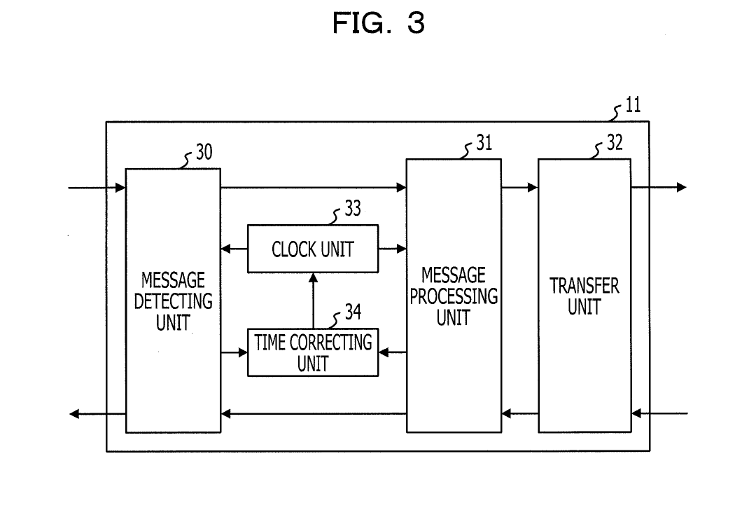

FIG. 3 is a detailed block diagram of the relay slave node 11. The relay slave node 11 includes a message detecting unit 30, a message processing unit 31, a transfer unit 32, a clock unit 33, and a time correcting unit 34. The terminal slave node 12 and the relay slave node 11 may have similar configurations in the present embodiment.

The message detecting unit 30 monitors the Sync messages and the FollowUp messages transmitted from the master node 10. The message detecting unit 30 refers to the clock unit 33 upon detecting a Sync message addressed to a slave node other than its own slave node, and transmits time information of the reception time of the message to the time correcting unit 34. The message detecting unit 30 detects a FollowUp message addressed to a slave node other than its own slave node and transmits time information extracted from the FollowUp message to the time correcting unit 34.

The relay slave node 11 described in the present embodiment may be connected to a plurality of terminal slave nodes. When the relay slave node 11 is connected to a plurality of terminal slave nodes, a plurality of time synchronization messages transmitted to the plurality of terminal slave nodes from the master node 10 pass through the relay slave node 11.

For example, when the plurality of time synchronization messages pass through the relay slave node 11 at substantially the same timing, detecting all the time synchronization messages and conducting the time synchronization processing results in a large processing load on the message detecting unit 30. When a plurality of time synchronization messages pass through the relay slave node 11, the message detecting unit 30 processes only the message detected first and stores the destination address of the detected message. Next, when a time synchronization message is received, the message detecting unit 30 detects a message addressed to the stored destination address and a message sent from the stored destination address, and ignores messages addressed to other addresses. By configuring the message detecting unit 30 as described above, the communication system 1 is capable of performing synchronization processing without causing an increase in processing loads even when there is a branch connection from one relay slave node to a plurality of terminal slave nodes.

The message processing unit 31 processes messages transmitted to its own slave node. The message processing unit 31 refers to the clock unit 33 upon detecting a Sync message addressed to its own slave node, and transmits the time information of the reception time of the message to the time correcting unit 34. The message processing unit 31 detects a FollowUp message addressed to its own slave node and transmits the time information extracted from the FollowUp message to the time correcting unit 34.

The message processing unit 31 generates a DelayReq message to be transmitted to the master node 10. The message processing unit 31 reads the time information of the transmission time of the message from the clock unit 33, and transmits the time information to the time correcting unit 34.

The clock unit 33 measures a transmission time and a reception time of a specified message. The clock unit 33 transmits the measured time to the message detecting unit 30 and the message processing unit 31 according to respective requests from the message detecting unit 30 and the message processing unit 31. The clock unit 33 corrects a current time according to a correction signal received from the time correcting unit 34.

The time correcting unit 34 receives time information related to synchronization processing from the message detecting unit 30 and the message processing unit 31. The time correcting unit 34 stores the received time information. The time correcting unit 34 calculates a correction time of the clock unit 33 based on the stored time information. The time correcting unit 34 transmits to the clock unit 33 the correction signal to correct the time of the clock unit 33 according to the calculated correction time.

The transfer unit 32 transfers to another node a service frame of an Ethernet transmission service received from the relay slave node 11. The transfer unit 32 transfers a service frame according to the destination address of the service frame. The transfer unit 32 includes, for example, an IEEE 802.1 Q bridge function.

The above-mentioned slave nodes are capable of performing time synchronization processing of the clock unit 33 based on the master node and the time synchronization message.

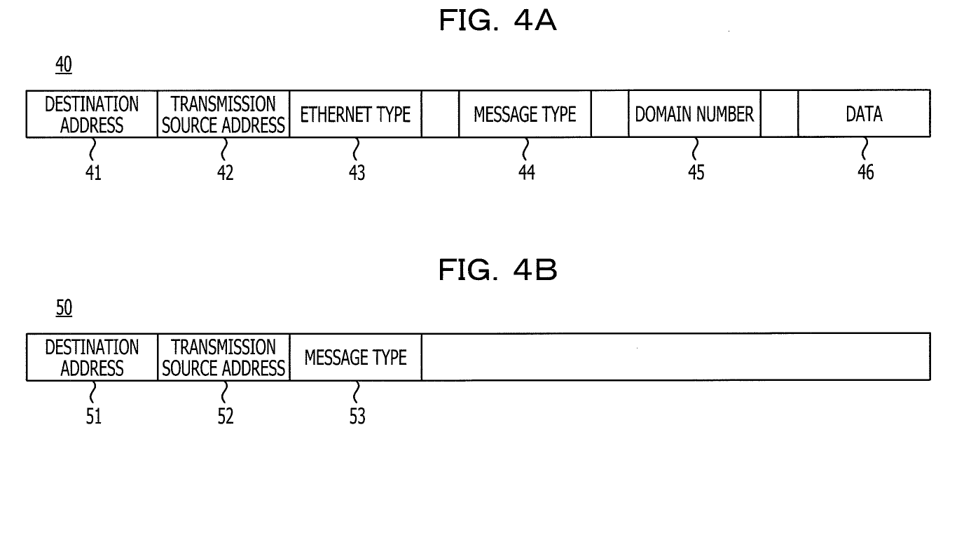

FIG. 4A illustrate configurations of various signals based on IEEE 1588. FIG. 4A illustrates a configuration of a time synchronization message 40. FIG. 4B illustrates a configuration of a Sync control signal 50.

The time synchronization message 40 illustrated in FIG. 4A includes a destination address 41, a transmission source address 42, an Ethernet type 43, a message type 44, a domain number 45, and data 46.

The destination address 41 is an address indicating a transmission destination node of the time synchronization message 40. For example, if the time synchronization message 40 is to be transmitted to the terminal slave node 12, the address of the terminal slave node 12 is inserted in the destination address 41.

The transmission source address 42 is an address indicating the transmission source node of the time synchronization message 40. For example, if the time synchronization message 40 is transmitted from the master node 10, the address of the master node 10 is inserted in the transmission source address 42.

The Ethernet type 43 is a symbol indicating the type of standard that determines the format of the time synchronization message 40. A symbol that indicates IEEE 1588 is inserted in the Ethernet type 0x88F7 in the present embodiment.

The message type 44 is a symbol indicating a type of the time synchronization message 40. The time synchronization message 40 types include a Sync message, a FollowUp message, a DelayReq message, and a DelayResp message in the present embodiment.

The domain number 45 is a symbol indicating a clock domain that is the subject of the synchronization processing. For example, if synchronization processing by the master node 10 is performed on a plurality of different slave nodes, each node inserts a symbol indicating to which clock domain the time synchronization message pertains in the domain number 45.

The data 46 is a data storage region. Content of this portion depends on the message type. In the case of a FollowUp message for example, time information of the corresponding Sync message transmission time is inserted as the data 46.

As illustrated in FIG. 4B, the Sync control signal 50 includes a destination address 51, a transmission source address 52, and a message type 53.

The destination address 51 is an address indicating a master node.

The transmission source address 52 is an address indicating the slave node that wishes to control Sync message generation.

The message type 53 is a symbol indicating a type of the Sync control signal 50. In the present embodiment, the Sync control signal 50 types include the Sync inhibition request signal and a Sync generation request signal.

The above-mentioned time synchronization message 40 has a data structure based on the IEEE 1588 standard.

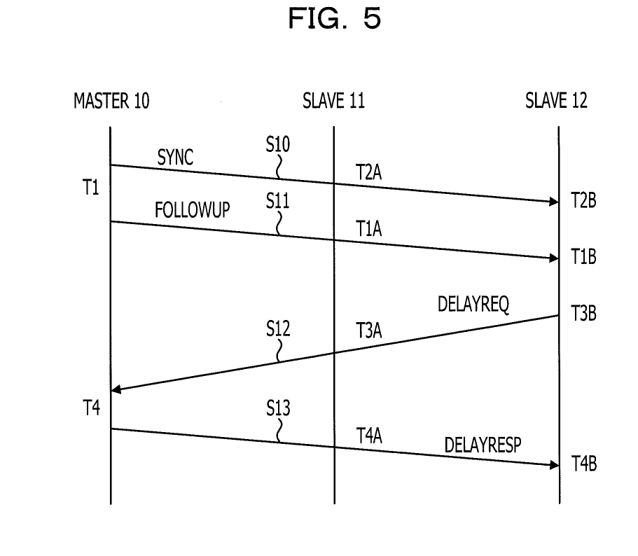

FIG. 5 is a sequence diagram illustrating a flow of time synchronization processing. An example of time synchronization processing of the slave nodes 11 and 12 will be explained with the clock of the master node 10 illustrated in FIG. 1 as the reference clock.

The Sync/FollowUp generating unit 24 of the master node 10 stores time information of a time T1 in which a Sync message was transmitted, and regularly transmits the Sync message to the terminal slave node 12 (S10).

The message detecting unit 30 of the relay slave node 11 detects the Sync message addressed to the terminal slave node 12 transmitted from the master node 10 and creates time information of a reception time T2A of the message. The message detecting unit 30 transmits the time information of the time T2A when the Sync message was received to the time correcting unit 34. The time correcting unit 34 stores the time information of the time T2A received from the message detecting unit 30. The transfer unit 32 of the relay slave node 11 transfers the received Sync message to the terminal slave node 12.

The message processing unit 31 of the terminal slave node 12 receives the Sync message addressed to the terminal slave node 12 transmitted from the relay slave node 11 and generates time information of a reception time T2B of the message by referring to the clock unit 33 of the terminal slave node 12. The message processing unit 31 transmits the time information of the time T2B when the Sync message was received to the time correcting unit 34. The time correcting unit 34 stores the time information of the time T2B received from the message processing unit 31.

The Sync/FollowUp generating unit 24 of the master node 10 transmits the FollowUp message that includes the stored Sync message transmission time information to the terminal slave node 12 (S11).

The message detecting unit 30 of the relay slave node 11 detects the FollowUp message addressed to the terminal slave node 12 transmitted from the master node 10 and extracts the time information from the message. The message detecting unit 30 transmits the extracted time information to the time correcting unit 34 as a time T1A. The time correcting unit 34 stores the time information of the time T1A received from the message detecting unit 30. The relay slave node 11 transfers the received FollowUp message to the terminal slave node 12.

The message processing unit 31 of the terminal slave node 12 receives the FollowUp message addressed to the terminal slave node 12 transferred from the relay slave node 11 and extracts the time information from the message. The message processing unit 31 transmits the extracted time information to the time correcting unit 34 as a time T1B. The time correcting unit 34 stores the time information of the time T1B received from the message processing unit 31.

The difference (|T2A−T1A|) between the time T1A and the time T2A is caused by an offset of the slave clock of the relay slave node 11 and a network propagation delay with respect to a master clock of the master node 10. The difference between the time T1B and the time T2B (|T2B−T1B|) is caused by an offset of the slave clock of the terminal slave node 12 and a network propagation delay with respect to a master clock of the master node 10.

The message processing unit 31 of the terminal slave node 12 generates a DelayReq message to be transmitted to the master node 10. The message processing unit 31 transmits the generated DelayReq message to the master node 10 (S12). The message processing unit 31 reads from the clock unit 33 time information of a time T3B which indicates the time the DelayReq message is transmitted. The message processing unit 31 transmits the read time information of the time T3B to the time correcting unit 34. The time correcting unit 34 stores the time information of the time T3B.

The message detecting unit 30 of the relay slave node 11 detects the DelayReq message transmitted to the master node 10 and reads time information of a time T3A which indicates the time the DelayReq message was detected. The message detecting unit 30 transmits the read time information of the time T3A to the time correcting unit 34. The time correcting unit 34 stores the time information of the time T3A.

The DelayResp generating unit 22 of the master node 10 reads time information of a reception time T4 from the clock unit 26 upon receiving the DelayReq message transmitted from the terminal slave node 12. The DelayResp generating unit 22 transmits a DelayResp message with the time information of the time T4 inserted therein to the terminal slave node 12 (S13).

The message detecting unit 30 of the relay slave node 11 detects the DelayResp message addressed to the terminal slave node 12 transmitted from the master node 10 and extracts the time information from the message. The message detecting unit 30 transmits the extracted time information to the time correcting unit 34 as a time T4A. The time correcting unit 34 stores the time information of the time T4A received from the message detecting unit 30. The relay slave node 11 transfers the received DelayResp message to the terminal slave node 12.

The message processing unit 31 of the terminal slave node 12 detects the DelayResp message addressed to the terminal slave node 12 transferred from the relay slave node 11 and extracts the time information from the message. The message processing unit 31 transmits the extracted time information to the time correcting unit 34 as a time T4B. The time correcting unit 34 stores the time information of the time T4B received from the message processing unit 31.

The difference (|T4A−T3A|) between the time T3A and the time T4A is caused by an offset of the slave clock of the relay slave node 11 and a network propagation delay with respect to a master clock of the master node 10. The difference (|T4B−T3B|) between the time T3B and the time T4B is caused by an offset of the slave clock of the terminal slave node 12 and a network propagation delay with respect to a master clock of the master node 10.

The time correcting unit 34 in the relay slave node 11 stores the time information of the times T1A, T2A, T3A, and T4A. The time correcting unit 34 calculates a propagation delay time TDELAY11 between the master node 10 and the relay slave node 11 based on the stored time information. The propagation delay time TDELAY11 may be obtained from TDELAY11={(T4A−T1A)−(T3A−T2A)}/2. A time lag TDIFF11 between the master node 10 and the relay slave node 11 may be obtained from TDIFF11=T2A−T1A−TDELAY11. If the time lag TDIFF11 is a positive value, the time of the relay slave node 11 is ahead of the master node 10. If the time lag TDIFF11 is a negative value, the time of the relay slave node 11 is behind the master node 10.

The time correcting unit 34 transmits the calculated time lag TDIFF11 to the clock unit 33. The clock unit 33 corrects the time based on the value of the received time lag TDIFF11.

The relay slave node 11 that is a relay slave node as described above may perform time adjustment processing with the master node 10 by monitoring time synchronization messages transmitted between the master node 10 and the terminal slave node 12.

Similarly, the time correcting unit 34 of the terminal slave node 12 stores the time information times T1B, T2B, T3B, and T4B. The time correcting unit 34 calculates a propagation delay time TDELAY12 between the master node 10 and the terminal slave node 12 based on the stored time information. The propagation delay time TDELAY12 may be obtained from TDELAY12={(T4B−T1B)−(T3B−T2B)}/2. A time lag TDIFF12 between the master node 10 and the terminal slave node 12 is obtained from TDIFF12=T2B−T1B−TDELAY12. If the time lag TDIFF12 is a positive value, the time of the terminal slave node 12 is ahead of the master node 10. If the time lag TDIFF12 is a negative value, the time of the terminal slave node 12 is behind the master node 10.

The time correcting unit 34 transmits the calculated time lag TDIFF12 to the clock unit 33. The clock unit 33 corrects the time based on the value of the received time lag TDIFF12. The above-mentioned slave node 12 is capable of performing time synchronization processing with the master node 10.

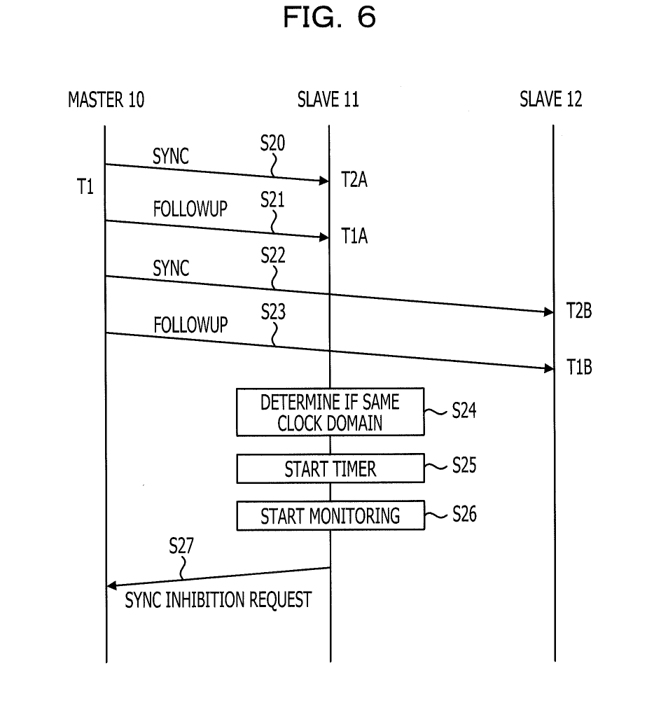

FIG. 6 is a sequence diagram illustrating an operation in the relay slave node 11 of switching from directly handling the time synchronization messages from the master node 10 to monitoring the time synchronization messages of the master node 10 and the terminal slave node 12 to perform synchronization processing.

Both the relay slave node 11 and the terminal slave node 12 according to the present embodiment receive provision of time synchronization from the master node 10. All the provided time synchronization messages in the present embodiment belong to the same time domain.

The relay slave node 11 receives the Sync message and the FollowUp message transmitted from the master node 10 (S20, S21). Similarly, the terminal slave node 12 receives the Sync message and the FollowUp message transmitted from the master node 10 (S22, S23).

The relay slave node 11 detects the messages transmitted from the master node 10 to the terminal slave node 12. The relay slave node 11 starts a count by a Sync timer (S25) when the clock domain of the detected message is the same as the clock domain of the message addressed to itself (S24).

The relay slave node 11 starts the Sync timer and starts monitoring the messages transmitted from the master node 10 to the terminal slave node 12 (S26). The relay slave node 11 transmits, to the master node 10, a Sync inhibition request signal that indicates that the transmission of the Sync message to itself is unnecessary (S27).

The relay slave node 11 as described above is capable of reducing the time synchronization processing load on the master node 10 by inhibiting the transmission of a message to itself from the master node 10 based on the result of monitoring the messages.

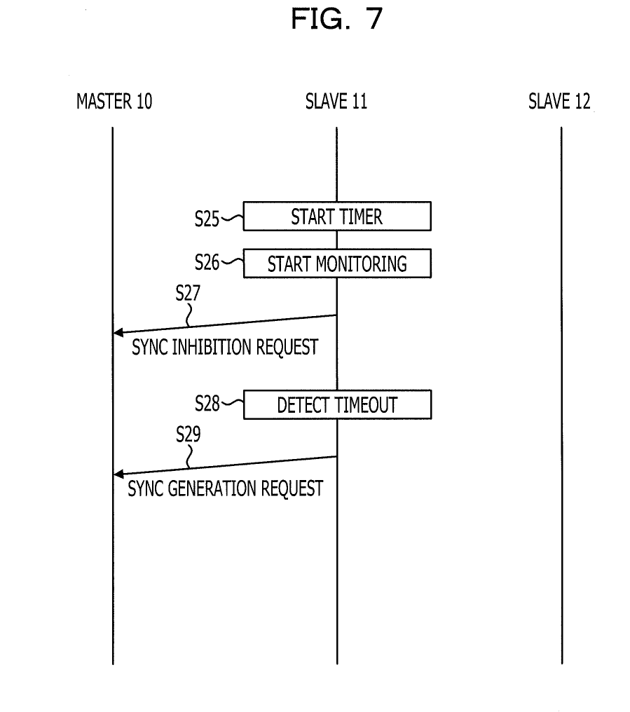

FIG. 7 is a sequence diagram explaining an operation of the relay slave node 11 after the monitoring processing has started. Reference numerals used in FIG. 7 that are the same as those in FIG. 6 refer to the same processes and explanations thereof will be omitted.

The relay slave node 11 detects a Sync message transmitted from the master node 10 to the terminal slave node 12, and starts a timer and transmits a Sync inhibition request signal to the master node 10. A value set for the Sync timer is determined, for example, according to a time period that allows for maintaining a precise time without the relay slave node 11 performing the time synchronization processing.

After the timer has started, the relay slave node 11 detects a timeout when the Sync message that passes through the slave nodes is not able to be detected before a certain time period has elapsed (S28). After detecting the timeout, the relay slave node 11 transmits, to the master node 10, a Sync generation request signal to cause the master node 10 to transmit Sync messages to the relay slave node 11 (S29).

The relay slave node 11 as described above is capable of guaranteeing the time synchronization processing when the Sync messages are not able to be transmitted to other slave nodes by setting a timeout after the Sync inhibition processing.

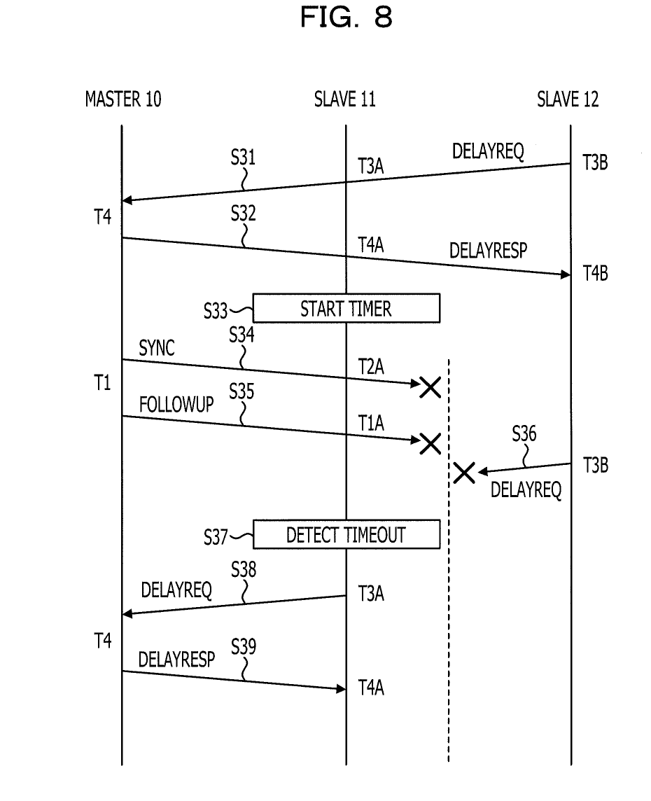

FIG. 8 is a sequence diagram describing time synchronization processing by the relay slave node 11 when a problem occurs on the network between the relay slave node 11 and the terminal slave node 12.

If no problem exists on the network between the relay slave node 11 and the terminal slave node 12, the relay slave node 11 is able to detect a DelayReq message transmitted from the terminal slave node 12 to the master node 10, and a DelayResp message transmitted from the master node 10 to the terminal slave node 12 (S31, S32).

The relay slave node 11 starts a DelayReq timer each time a DelayReq message transmitted from the terminal slave node 12 to the master node 10 is detected (S33). A value of the DelayReq timer is determined, for example, according to a time period that allows for a precise time without the relay slave node 11 performing the time synchronization processing.

When a problem occurs on the network between the relay slave node 11 and the terminal slave node 12, the Sync message and the FollowUp message transmitted from the master node 10 do not reach the terminal slave node 12 even though the relay slave node 11 is able to detect the same messages (S34, S35). The DelayReq message transmitted from the terminal slave node 12 to the master node 10 does not reach the relay slave node 11 (S36). When the DelayReq message transmitted from the terminal slave node 12 to the master node 10 is not able to be detected by the relay slave node 11 before a certain time period has elapsed, the relay slave node 11 detects a timeout (S37).

After detecting the timeout, the relay slave node 11 transmits the DelayReq message to the master node 10 (S38). The relay slave node 11 stores the time information of the time T3A which indicates the time the DelayReq message was transmitted.

Upon receiving the DelayReq message from the relay slave node 11, the master node 10 transmits a DelayResp message with the time information of the time T4A inserted therein to the relay slave node 11 (S39). The relay slave node 11 stores the time information extracted from the received DelayResp message as the time T4A.

The relay slave node 11 as described above is capable of continuing time synchronization processing even when a problem occurs on the network between the relay slave node 11 and the terminal slave node 12.

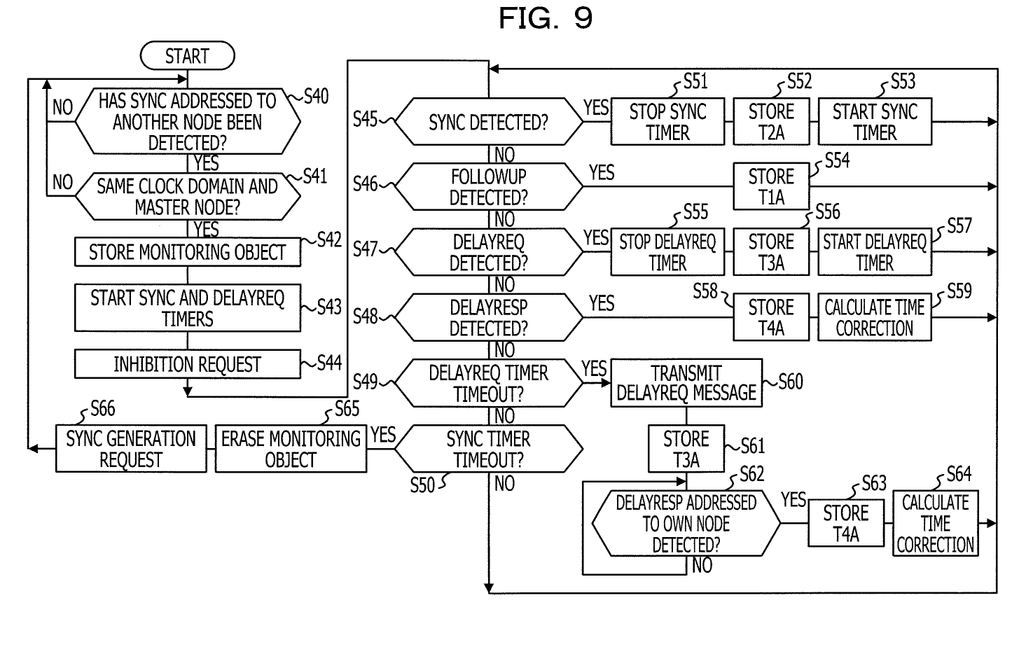

FIG. 9 illustrates a process flow of the relay slave node 11.

The message detecting unit 30 in the relay slave node 11 detects a transmitted Sync message addressed to another slave node (S40: Yes). If the master node that is the transmission source of the detected Sync message is the same and the clock domain is the same (S41: Yes), the message detecting unit 30 stores the address of the other slave node as a monitoring object (S42).

The message detecting unit 30 includes the Sync timer for monitoring the Sync messages, and the DelayReq timer for monitoring the DelayReq messages. After the message detecting unit 30 stores the address of the slave node that is the monitoring object, the message detecting unit 30 starts the Sync timer and the DelayReq timer (S43). The message detecting unit 30 transmits a Sync inhibition request signal to the master node 10 (S44).

When a Sync message is detected after starting the Sync timer (S45), the message detecting unit 30 stops the Sync timer (S51). The message detecting unit 30 reads the time when the Sync message was received from the clock unit 33 and transmits the read time as the time T2A to the time correcting unit 34. The time correcting unit 34 stores the received time information of the received time T2A (S52). The message detecting unit 30 resets the stopped Sync timer and then starts the Sync timer (S53).

When the message detecting unit 30 detects a FollowUp message (S46: Yes), the message detecting unit 30 extracts the time information from the message and transmits the time information as the time T1A to the time correcting unit 34. The time correcting unit 34 stores the received time information indicating the received time T1A (S54).

When the message detecting unit 30 detects a DelayReq message (S47: Yes), the message detecting unit 30 stops the DelayReq timer (S55). The message detecting unit 30 reads the time when the DelayReq message was received from the clock unit 33 and transmits the read time as the time T3A to the time correcting unit 34. The time correcting unit 34 stores the received time information of the received time T3A (S56). The message detecting unit 30 resets the stopped DelayReq timer and then starts the DelayReq timer (S57).

When the message detecting unit 30 detects a DelayResp message (S48: Yes), the message detecting unit 30 extracts the time information from the message and transmits the time information to the time correcting unit 34 as the time T4A. The time correcting unit 34 stores the received time information indicating the received time T4A (S58). The time correcting unit 34 performs time correction calculations based on the stored time information of the times T1A, T2A, T3A, and T4A (S59).

When the DelayReq message that passes through the slave nodes is not able to be detected before a certain time period has elapsed after starting the DelayReq timer, the message detecting unit 30 detects a timeout (S49: Yes). After detecting the timeout, the message processing unit 31 of the relay slave node 11 transmits, to the master node 10, a DelayReq message to cause the master node 10 to transmit the DelayResp messages to the relay slave node 11 (S60).

The message processing unit 31 reads, from the clock unit 33, time information of the time T3A which indicates when the DelayReq message was transmitted. The message processing unit 31 transmits the read time information of the time T3A to the time correcting unit 34. The time correcting unit 34 stores the received time information of the received time T3A (S61).

When the message processing unit 31 detects the DelayResp message addressed to its own slave node regarding the DelayReq message transmitted to the master node 10 (S62: Yes), the message processing unit 31 inserts the time information in the message and transmits the message to the time correcting unit 34 as the time information of the time T4A. The time correcting unit 34 stores the received time information of the received time T4A (S63). The time correcting unit 34 performs time correction calculations based on the stored time information of the times T1A, T2A, T3A, and T4A (S64).

When the DelayReq message that passes through the slave nodes is not able to be detected before a certain time period has elapsed after starting the Sync timer, the message detecting unit 30 detects a timeout (S50: Yes). After detecting the timeout, the message detecting unit 30 erases the address of the terminal slave node stored as the monitoring object (S65). The message detecting unit 30 transmits, to the master node 10, a Sync generation request signal to cause the master node 10 to transmit Sync messages to the relay slave node 11 (S66). The master node 10 that receives the Sync generation request signal restarts the transmission of the stopped Sync messages addressed to the relay slave node 11.

The relay slave node 11 as described above is capable of reducing the amount of synchronization processing addressed to itself from the master node 10, and is capable of restarting the same processing addressed to itself when desired.

According to the above embodiment, the master node 10 and the relay slave node 11 include, for example, a processor, a memory, an analog circuit, a digital circuit, a communication interface, and the like. The processor is a data processing device and includes, for example, a central processing unit (CPU) and a digital signal processor (DSP) and the like. The memory is a device for storing data and includes, for example, a read only memory (ROM) and a random access memory (RAM), and the like. The analog circuit is a circuit for processing analog signals. The digital circuit is a circuit for processing digital signals, and includes, for example, a large scale integrated circuit (LSI), a field-programming gate array (FPGA), and an application specific integrated circuit (ASIC), and the like. The communication interface is a device for conducting communication with another node through a network, and includes, for example, an Ethernet (registered trademark) port, a wireless antenna, and the like.

According to the above embodiment, functions of the master node 10 illustrated in FIG. 2 may be implemented by hardware. For example, the demultiplexer 20, the Sync/FollowUp generating unit 24, the Sync inhibition processing unit 21, the DelayResp generating unit 22, the message processing unit 23, the multiplexer 25, and the clock unit 26 may each be implemented by the processor, the memory, or the digital circuit. Functions of the relay slave node 11 illustrated in FIG. 3 may be implemented by hardware. For example, the message detecting unit 30, the message processing unit 31, the transfer unit 32, the clock unit 33, and the time correcting unit 34 may each be implemented by the processor, the memory, or the digital circuit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A node device that conducts time synchronization processing, the node device comprising:
a processor configured
to measure a reception time of a time synchronization message transmitted addressed to another node device from a master node device, the time synchronization message including information of a transmission time from the master node device,
to detect the time synchronization message, and extracts information of the transmission time from the detected time synchronization message, and
to correct a time in the processor based on the extracted information of the transmission time and the information of the reception time; and
a transmitter configured to forward the time synchronization message to the another node device when the time synchronization message received by a receiver addressed to the another node device.

2. The node device according to claim 1,
wherein the processor measures a reception time of a reply message transmitted to the master node device in response to the another node device replying to the time synchronization message,
the processor detects the reply message and extracts information of a reply time indicating when the another node device transmitted the reply message, and
the processor corrects a time in the processor based on the information of the reception time and the information of the reply time of the reply message.

3. The node device according to claim 1,
wherein the processor configured to control the transmitter to transmit, to the master server, a stop request signal to stop time synchronization message transmission from the master server to the node device according to the detection of the time synchronization message.

4. The node device according to claim 1,
wherein the processor stores the address of the other node device, and detects the time synchronization message received from the master node device based on the stored address.

5. A communication system comprising:
a first node device,
a second node device,
and a master node device that transmits a message addressed to the second node device via the first node device,
wherein the master node device includes
a first processor that is configured
to generate a time synchronization message that includes information of the transmission time, and
to measures the transmission time of the time synchronization message, and
a first transmitter that is configured to transmit the time synchronization message generated by the first processor to the second node device; and
the first node device includes
a second processor that is configured
to measure a reception time of the time synchronization message transmitted from the master node device,
to detect the time synchronization message, and extracts information of the transmission time from the time synchronization message,
to correct a time in the processor based on the extracted information of the transmission time and the information of the reception time, and
a second transmitter that is configured to forward the time synchronization message to the second node device that is the destination of the time synchronization message when the time synchronization message detected by the second processor is addressed to the second node device.

6. The communication system according to claim 5,
wherein the second node device includes
a third processor that is configured
to generate a reply message to reply to the time synchronization message, and
to measure a reply time to transmit the reply message to the master node device; and
wherein the second processor is configured
to measure a reception time of the reply message transmitted to the master node device from the second node device,
to detect the reply message and extracts information of a reply time indicating when the another node device transmitted the reply message, and
to correct a time of the second processor based on the information of the reception time and the information of the reply time of the reply message.

7. The communication system according to claim 5,
wherein the second processor transmits, to the master server, a stop request signal to request a stoppage of transmission of the time synchronization message addressed to the first node device from the master server, when the time synchronization message addressed to the second node device includes information of the transmission time based on a clock domain that is the same as that of the time synchronization message addressed to the first node device.

8. The communication system according to claim 5,
wherein the second processor stores the address of the second node device, and detects the time synchronization message received from the master node device based on the stored address.

9. A time synchronization method, the time synchronization method comprising:
measuring by a node device, a reception time of a time synchronization message transmitted addressed to another node device from a master node device, the time synchronization message including information of a transmission time from the master node device;
detecting by the node device, the time synchronization message, and extracts information of the transmission time from the detected time synchronization message;
correcting by the node device, a time in the processor based on the extracted information of the transmission time and the information of the reception time; and
forwarding by the node device, the time synchronization message to the another node device when the time synchronization message received by a receiver addressed to the another node device.

10. The time synchronization method according to claim 9,
wherein the measuring measures a reception time of a reply message transmitted to the master node device in response to the another node device replying to the time synchronization message,
the detecting detects the reply message and extracts information of a reply time indicating when the another node device transmitted the reply message, and
the correcting corrects a time in the node device based on the information of the reception time and the information of the reply time of the reply message.

11. The time synchronization method according to claim 9,
wherein the detecting transmits, to the master server, a stop request signal to stop time synchronization message transmission from the master server to the node device according to the detection of the time synchronization message.

12. The time synchronization method according to claim 9,
wherein the detecting stores the address of the other node device, and detects the time synchronization message received from the master node device based on the stored address.
